(19) United States
(12) Patent Application Publication
(10) Pub. No.: US 2019/0212875 A1
(43) Pub. Date: Jul. 11, 2019

(54) TOUCH SENSOR EXPOSED AND TOUCH AREA AND WRITING AREA INTERACTION ELECTRONIC WHITEBOARD

(71) Applicant: Suzhou Maxpad Technologies Co., Ltd, Jiangsu Province (CN)

(72) Inventor: Huaming WANG, Jiangsu Province (CN)

(21) Appl. No.: 15/868,154

(22) Filed: Jan. 11, 2018

(51) Int. Cl. G06F 3/042

(52) U.S. Cl. CPC G06F 3/0425; G06F 2203/04103

(57) ABSTRACT

The present utility model discloses a touch sensor exposed and touch area and writing area integrated electronic whiteboard. A frame is disposed around an electronic whiteboard body. An inner side wall of the frame is provided with an optical reflection strip. Infrared cameras are disposed in upper and lower frames of the frame. The infrared cameras protrude from the optical reflection strip. The two infrared cameras both face a side of the electronic whiteboard body. The two infrared cameras separate the electronic whiteboard body into a touch area and a writing area. A computer host is embedded into the frame in the touch area. A projector is disposed above the touch area, and the projector is connected to the computer host.

### FIELD OF THE UTILITY MODEL

The present utility model relates to an electronic whiteboard, and in particular, to a touch sensor exposed and touch area and writing area integrated electronic whiteboard.

### BACKGROUND OF THE UTILITY MODEL

A whiteboard is widely applied to the office work field and the teaching field. Currently, there is a pure whiteboard in the market on which writing is performed by using a whiteboard marker. Certainly, with the development of computer technologies and electronic technologies, an electronic product integrating functions of a computer and a projector, that is, an electronic whiteboard, emerges, which can timely, conveniently, and flexibly introduce multiple types of digital information resources to make digital resources displayed more flexibly, and can also perform a function of timely storing content written on the board to facilitate subsequent use. With such advantages, the electronic whiteboard is more widely used as a teaching and training device.

The electronic whiteboard can flexibly display information, but some users are still used to an ordinary whiteboard, or needs an ordinary whiteboard to write information. Certainly, there currently are some dual-purpose electronic whiteboards (which may function as an electronic whiteboard and a writing whiteboard). However, the whiteboards can be used in only one mode at one time. That is, when the electronic whiteboard is used, the writing whiteboard cannot be used, and information on the writing whiteboard cannot be clearly seen. Similarly, when the ordinary whiteboard is used, information on the ordinary whiteboard can be clearly seen only after the electronic whiteboard is turned off. The two modes cannot be implemented at the same time.

### SUMMARY OF THE UTILITY MODEL

To overcome the foregoing disadvantage, the objective of the present utility model is to provide a touch sensor exposed and touch area and writing area integrated electronic whiteboard, on which content can be clearly seen and an electronic whiteboard and an ordinary whiteboard can be used at the same time.

To achieve the foregoing objective, a technical solution used in the present utility model is a touch sensor exposed and touch area and writing area integrated electronic whiteboard, comprising: an electronic whiteboard body and infrared cameras. A frame is disposed around the electronic whiteboard body. An inner side wall of the frame is provided with an optical reflection strip. The infrared cameras are disposed in upper and lower frames of the frame. The infrared cameras protrude from the optical reflection strip. The two infrared cameras both face a side of the electronic whiteboard body. The two infrared cameras separate the electronic whiteboard body into a touch area and a writing area. A computer host is embedded into the frame in the touch area. A projector is disposed above the touch area, and the projector is connected to the computer host.

Beneficial effects of the infrared camera exposed and touch area and writing area integrated electronic whiteboard in the present utility model are as follows: The two infrared cameras separate the electronic whiteboard body into a touch area and a writing area. The touch area and the writing area are presented to a user intuitively, the user may use the two whiteboards at the same time, and the two whiteboards do not affect each other, thereby meeting a user requirement. Touch control of the touch area is implemented by cooperation between the projector and the computer host, and the touch area and the writing area are not physically separated but integrally disposed, thereby bring the advantages of being neat and aesthetic. The length and width of the touch area may be set according to a user requirement, which is convenient. In addition, the infrared cameras protrude from the optical reflection strip, so that light emitted by the infrared cameras is not blocked by the frame, implementing precise touch control.

Preferably, the size of the touch area is 60 inches to 120 inches. The size of the touch area is adjustable. When the two infrared cameras are installed, left and right positions of the infrared cameras are set first, and then installation is performed, thereby implementing adjustment of the size of the touch area according to a requirement.

### BRIEF DESCRIPTION OF THE DRAWINGS

FIG. 1 is a schematic structural diagram in which a touch area is located on a left side of an electronic whiteboard body according to Embodiment 1; and

FIG. 2 is a schematic structural diagram in which a touch area is located on a right side of an electronic whiteboard body according to Embodiment 2.

In the Figures: 1: Frame; 2: Optical reflection strip; 3: Electronic whiteboard body; 4: Control mainboard; 5: Infrared camera; 6: Touch area; 7: Writing area; 8: Computer host; and 9: Projector.

### DETAILED DESCRIPTION OF THE UTILITY MODEL

To enable persons skilled in the art to more easily understand the advantages and features of the present utility model, the following provides a detailed description with reference to the accompanying drawings by using preferred embodiments of the present utility model, to define the protection scope of the present utility model clearer.

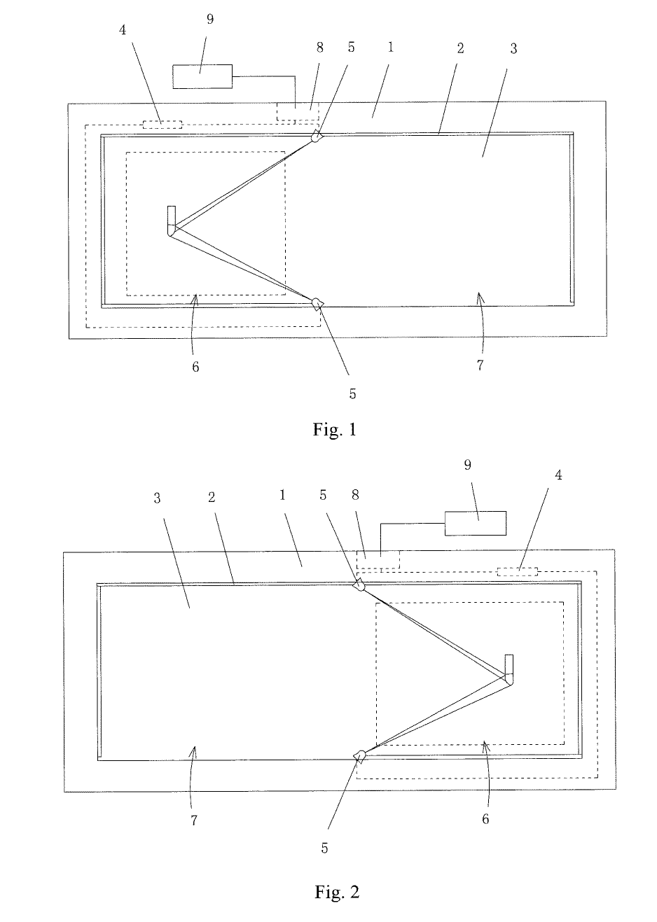

In Embodiment 1, referring to FIG. 1, a touch sensor exposed and touch area and writing area integrated electronic whiteboard in this embodiment comprises an electronic whiteboard body 3 and infrared cameras 5. A frame 1 is disposed around the electronic whiteboard body 3. An inner side wall of the frame 1 is provided with an optical reflection strip 2. The infrared cameras 5 are disposed in upper and lower frames of the frame 1. The infrared cameras 5 protrude from the optical reflection strip 2. The two infrared cameras 5 both face a side of the electronic whiteboard body 3. The two infrared cameras 5 separate the electronic whiteboard body 3 into a touch area 6 and a writing area 7. A computer host 8 is embedded into the frame 1 in the touch area 6. A projector 9 is disposed above the touch area 6. The projector 9 is connected to the computer host 8. The computer host 8 is connected to the electronic whiteboard body 3 in the touch area 6.

When the two infrared cameras 5 are installed, left and right positions of the two infrared cameras 5 may be adjusted according to a requirement, to adjust the size of the touch area 6. The size of the touch area 6 may be 60 inches to 120 inches.

An infrared touch control principle belongs to the prior art. Each infrared camera has an LED light source (not shown in the figure) inside. The LED light source emits infrared light to the optical reflection strip opposite, and the optical reflection strip reflects the infrared light emitted by the LED to the camera. If there is no object operating on the electronic whiteboard body, the infrared camera receives the reflected light of the optical reflection strip. Once there is an object operating on the electronic whiteboard body, the infrared light of the LED light source cannot reach the optical reflection strip, and the infrared camera cannot detect the reflected light. According to the principle, the two infrared cameras 5 transmit detected signals to the control mainboard 4. The control mainboard 4 is connected to the computer host 8. The control mainboard calculates data of a touch point on the optical reflection strip, to obtain touch coordinates (X, Y).

In Embodiment 2, as shown in FIG. 2, different from Embodiment 1, the infrared cameras 5 face the right side of the electronic whiteboard body 3. That is, the right side of the electronic whiteboard body 3 is the touch area 6, and the left right is the writing area 7.

The aforementioned implementations are merely to explain the technical ideas and features of the present utility model, intended to help persons skilled in the art to understand and implement the present utility model, and not intended to limit the protection scope of the present utility model. Various equivalent variations or modifications made without departing from the spirit and essence of the present utility model shall fall within the protection scope of the present utility model.

1. A touch sensor exposed and touch area and writing area integrated electronic whiteboard, comprising: an electronic whiteboard body (3) and infrared cameras (5), wherein a frame (1) is disposed around the electronic whiteboard body (3), and an inner side wall of the frame (1) is provided with an optical reflection strip (2), wherein: the infrared cameras (5) are disposed in upper and lower frames of the frame (1), the infrared cameras (5) protrude from the optical reflection strip (2), the two infrared cameras both face a side of the electronic whiteboard body (3), the two infrared cameras (5) separate the electronic whiteboard body (3) into a touch area (6) and a writing area (7), a computer host (8) is embedded into the frame (1) in the touch area (6), a projector (9) is disposed above the touch area (6), and the projector (9) is connected to the computer host (8).

2. The touch sensor exposed and touch area and writing area integrated electronic whiteboard according to claim 1, wherein: the size of the touch area (6) is 60 inches to 120 inches.
